(19) United States
(12) Patent Application Publication
(10) Pub. No.: US 2013/0234517 A1
(43) Pub. Date: Sep. 12, 2013

(54) POWER ACCUMULATION SYSTEM AND METHOD FOR CONTROLLING STORAGE MODULE

(71) Applicant: Takeshi Uchida, Otokuni-gun (JP)

(72) Inventor: Takeshi Uchida, Otokuni-gun (JP)

(73) Assignee: HITACHI, LTD., Tokyo (JP)

(21) Appl. No.: 13/698,969

(22) PCT Filed: Mar. 12, 2012
(86) PCT No.: PCT/JP2012/056275

§ 371 Date: Nov. 19, 2012

(51) Int. Cl. H02J 7/00

(52) U.S. Cl. CPC H02J 7/0022
USPC 307/46

(57) ABSTRACT

A power accumulation system according to the present invention includes a plurality of storage bodies (206, 207) each being capable of storing predetermined electric power; a power conversion device (203) inputting and outputting electric power with respect to the storage bodies; and a control device (202) controlling motion of the power conversion device. At least part of the storage bodies is a storage module that includes storage elements capable of storing electric power and an input/output characteristic adjustment part for controlling input/output characteristics of electric power of the storage elements. In the power accumulation system of the present invention, it is possible to easily control the entire power accumulation system even after replacement of the storage bodies.

### TECHNICAL FIELD

The present invention relates to a power accumulation system provided with a plurality of storage bodies that store electric power, and a method for controlling a storage module as a storage body used in the power accumulation system.

### BACKGROUND ART

A power accumulation system has a function of accumulating large electric power. When there is surplus power supply, the power accumulation system stores electric power in cooperation with a power supply system or a power load system, and supplies the stored electric power when receiving a power supply request.

The power accumulation system can be used in various ways, and the scale varies depending on the intended use. For example, some are used as load variation suppressors of household equipments and server centers, some are used as countermeasures for power failures and regenerative electric power absorption systems of electric railroads, and further, some are used as renewable energy power generation systems such as wind power plants, and also for stabilizing large-scale systems such as nuclear power plants.

Here, a specific example of use of the power accumulation system will be described.

In the case where the power accumulation system is connected to a power system, stores electricity, and is requested to supply electric power from the power system, it supplies the stored electric power to the power system. In some cases, a power generation system connected to the power system is not a power generation system that supplies electric power stably (e.g., nuclear power generation), but a power generation facility whose generated electric power varies based on natural conditions, which change frequently (e.g., wind power generation and solar power generation). Further, load power required by a load sometimes varies, which sometimes does not meet the system that supplies electric power stably. In such a case, by performing control using the power accumulation system so that electricity is stored in the state where there is surplus generated electric power to be supplied to the power system over load power to be supplied to the load, whereas the stored electric power is supplied in the state where there is no surplus generated electric power over load power to be supplied to the load, the power system can supply electric power stably, or the efficiency of the power system can be improved.

Patent Document 1 describes a technology related to the power system to which the power accumulation system is connected. Patent Document 2 discloses a technology of controlling the power accumulation system for the case where power generation capacity varies, such as wind power generation.

### PRIOR ART DOCUMENT

### Patent Document

Patent Document 1: JP 09 (1997)-065588 A
Patent Document 2: JP 2007-124780 A

### DISCLOSURE OF INVENTION

### Problem to be Solved by the Invention

There has been known a power accumulation system that includes a plurality of storage units as storage bodies, each functioning as a rechargeable battery, and that is used by inputting and outputting electric power to the respective storage units. When part of the storage units fails during the use of such a power accumulation system, the failed unit is replaced by new one to secure the use of the power accumulation system as a whole. However, in this case, electric characteristics regarding charge/discharge of the storage units may vary greatly between the replaced new storage unit and the other storage units having been used continuously without replacement.

For example, when the production of conventional storage units is limited by countermeasures for environmental pollution by waste, or when the storage units are modified for improvement of performance, etc., and replaced by storage units with new specification, etc., it sometimes becomes difficult or impossible to obtain conventionally used storage units. For controlling the input/output of electric power of the entire power accumulation system by the collective control of a plurality of storage units, the variation in electric characteristics regarding charge/discharge of the respective storage units will be a problem in controlling the entire power accumulation units accurately.

The present invention solves such a conventional technical problem, and its object is to obtain a power accumulation system with a plurality of storage bodies, which can be controlled entirely with ease even after replacement of storage bodies. Further, the object of the present invention is to obtain a method for controlling a storage module that facilitates the control of the power accumulation system when the storage module is used as a storage body in the power accumulation system.

### Means for Solving Problem

To solve the above-described problem, a power accumulation system of the present invention is a power accumulation system that includes: a plurality of storage bodies each being capable of storing predetermined electric power; a power conversion device inputting and outputting electric power with respect to the storage bodies; and a control device controlling motion of the power conversion device. At least part of the storage bodies is a storage module that includes storage elements capable of storing electric power and an input/output characteristic adjustment part for controlling input/output characteristics of electric power of the storage elements.

Further, a method for controlling a storage module of the present invention is a method for controlling a storage module that includes storage elements capable of storing electric power and an input/output characteristic adjustment part for controlling input/output characteristics of electric power of the storage elements, and that is used as a storage body whose electric power is input and output by a power conversion device in a power accumulation system. The input/output characteristic adjustment part approximates input/output characteristics of the storage module to input/output characteristics of another storage body used in the power accumulation system.

### Effect of the Invention

In the power accumulation system of the present invention, since at least part of the storage bodies storing predetermined electric power is a storage module, input/output characteristics of the storage bodies can be matched with each other, whereby a plurality of storage bodies can be controlled collectively with ease in the power accumulation system.

Further, in the method for controlling a storage module, the input/output characteristic adjustment part for controlling input/output characteristics of electric power of the storage elements can approximate input/output characteristics of the storage module to input/output characteristics of another storage body used in the power accumulation system. Thereby, the storage module can be used in the same manner as the other storage bodies in the power accumulation system.

### BRIEF DESCRIPTION OF DRAWINGS

FIG. 1 is a diagram for illustrating a configuration of a power system in which a power accumulation system is arranged.

FIG. 2 is a system schematic configuration view showing an entire configuration of the power accumulation system according to Embodiment 1 of the present invention.

FIG. 3 is a view showing a schematic configuration of a storage module used in the power accumulation system according to Embodiment 1.

FIG. 4 is a block diagram showing a schematic configuration of an input/output characteristic adjustment part of the storage module used in the power accumulation system according to Embodiment 1.

FIG. 5 is a schematic block diagram showing a configuration of the storage module used in the power accumulation system according to Embodiment 1.

FIG. 6 is a schematic block diagram of the power accumulation system according to Embodiment 1.

FIG. 7 is a flowchart showing control operations in the input/output characteristic adjustment part of the storage module used in the power accumulation system according to Embodiment 1.

FIG. 8 shows schematic configurations of storage modules used in a power accumulation system according to Embodiment 2 of the present invention. FIG. 8A shows a schematic configuration of a first storage module, and FIG. 8B shows a schematic configuration of a second storage module.

FIG. 9 is a characteristic view for illustrating a method for matching characteristics of a voltage value and a remaining capacity between terminals of different storage modules.

### DESCRIPTION OF THE INVENTION

A power accumulation system of the present invention is a power accumulation system that includes: a plurality of storage bodies each being capable of storing predetermined electric power; a power conversion device inputting and outputting electric power with respect to the storage bodies; and a control device controlling motion of the power conversion device. At least part of the storage bodies is a storage module that includes storage elements capable of storing electric power and an input/output characteristic adjustment part for controlling input/output characteristics of electric power of the storage elements.

With this configuration, input/output characteristics of the storage module can be approximated to input/output characteristics of another storage body. Consequently, input/output characteristics of the storage bodies used in the power accumulation system can be equalized, whereby the control by the power conversion device for inputting and outputting electric power with respect to the storage bodies in the power accumulation system can be performed collectively and easily.

In the power accumulation system of the present invention, it is preferable that the storage module is arranged as a replacement for a storage unit that is formed by combining storage elements, and the input/output characteristic adjustment part of the storage module approximates input/output characteristics of the storage module to input/output characteristics of the replaced storage unit in actual working conditions. With this configuration, even when the storage body needs to be replaced, the control by the power conversion device for inputting and outputting electric power with respect to the storage bodies in the power accumulation system can be performed collectively and easily without any change before and after the replacement of the storage body.

Further, it is preferable that the power accumulation system further includes, as the storage bodies, a first storage module capable of storing electric power by means of first storage elements and a second storage module capable of storing electric power by means of second storage elements having characteristics different from characteristics of the first storage elements, wherein the input/output characteristic adjustment part of the second storage module approximates input/output characteristics of the second storage module to input/output characteristics of the first storage module. With this configuration, even when the storage modules provided with different types of storage elements are used in combination, the control by the power conversion device for inputting and outputting electric power with respect to the storage bodies in the power accumulation system can be performed collectively and easily.

Further, it is preferable that the second storage module is arranged as a replacement for the first storage module. With this configuration, the control by the power conversion device can be the same before and after the replacement of the storage module.

Further, it is preferable that the input/output characteristic adjustment part changes input/output characteristics of the storage module by manipulation from the outside of the storage module. With this configuration, even when characteristics of the storage body changes from the initial setting conditions, the approximation of input/output characteristics can be realized with high accuracy.

A method for controlling a storage module of the present invention is a method for controlling a storage module that includes storage elements capable of storing electric power and an input/output characteristic adjustment part for controlling input/output characteristics of electric power of the storage elements, and that is used as a storage body whose electric power is input and output by a power conversion device in a power accumulation system. The input/output characteristic adjustment part approximates input/output characteristics of the storage module to input/output characteristics of another storage body used in the power accumulation system.

With this configuration, since input/output characteristics of the storage module is approximated to input/output characteristics of another storage body, it is possible to realize a storage module that allows the power conversion device to input and output electric power with respect to the storage bodies collectively and easily when the storage module is used in the power accumulation system.

In the method for controlling a storage module of the present invention, it is preferable that, when the storage module is arranged in the power accumulation system as a replacement for another storage body, input/output characteristics of the storage module is approximated to input/output characteristics of the replaced another storage body. With this configuration, even when the storage body needs to be replaced in the power accumulation system, the control by the power conversion device for inputting and outputting electric power with respect to the storage bodies in the power accumulation system can be performed collectively and easily without any change before and after the replacement of the storage body.

Further, it is preferable that the another storage body replaced by the storage module is a storage unit that is formed by combining storage elements. With this configuration, even when the storage unit needs to be replaced, the collective control of the storage bodies in the power conversion device becomes possible.

Further, it is preferable that the another storage body replaced by the storage module is a storage module different from the storage module, which includes another storage elements having input/output characteristics different from input/output characteristics of the storage elements used in the storage module and an input/output characteristic adjustment part for controlling the input/output characteristics. With this configuration, the collective control of the storage bodies in the power conversion device becomes possible using a plurality of storage modules having different characteristics.

Further, it is preferable that a terminal voltage of the storage module is approximated to a terminal voltage of the replaced storage module different from the storage module, based on a relationship between the terminal voltage and a remaining capacity in the replaced storage module different from the storage module. With this configuration, it is possible to favorably approximate input/output characteristics of the storage modules having different storage capacities.

In this case, it is preferable that the terminal voltage of the storage module is approximated to the terminal voltage of the replaced storage module different from the storage module, so as to have a predetermined width above and below a value of the terminal voltage of the replaced storage module different from the storage module, at a predetermined capacity. With this configuration, it is possible to favorably approximate input/output characteristics of the storage modules having different storage capacities easily and reliably.

Hereinafter, a power accumulation system of the present invention and a method for controlling a storage module will be described with reference to the drawings.

In the following drawings, the same members are denoted with the same reference numerals, and the description may not be omitted arbitrarily. Further, in the block diagrams illustrating block configurations, groups of configurations having respective functions are shown as blocks, and a segment of block does not indicate a segment of a member, such as a circuit board having the block function. In other words, plural block functions may be realized by one member, and one block function may require plural members.

[Description of Power Generation System]

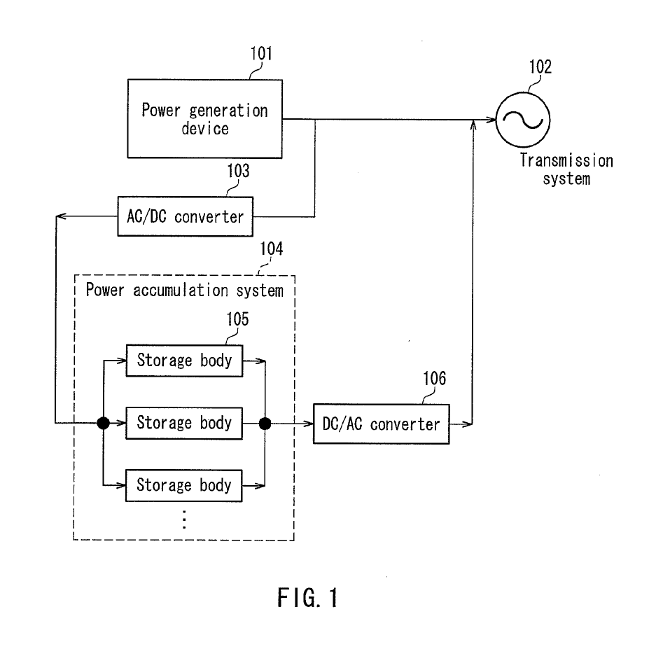

FIG. 1 is a schematic block diagram showing a configuration of a power generation system as a power system in which a power accumulation system according to the present invention is arranged.

In the power generation system shown in FIG. 1, electric power generated by a power generation device 101 is transmitted to a transmission system 102, and sent via the transmission system 102 to a power load (not shown) connected to the end of the transmission system 102.

Specific examples of the power generation device 101 include a wind power generation device that generates electricity based on wind power, a hydraulic power generation device that generates electricity based on hydraulic power, and a solar power generation device that generates electricity based on solar light. The power accumulation system according to the present invention does not specify a power generation mode of the power generation system. Further, even when a configuration of the power generation system is not clarified, the power accumulation system of the present invention is applicable, as long as it can receive a supply of power to be accumulated.

Recently, as the configuration of the power generation device, power generation devices that are friendly to the natural environment and have little impact on the natural environment have received attention. Typical examples of these include the above-described wind power generation device, the hydraulic power generation device and the solar power generation device. However, although the power generation devices generating electricity based on these natural energies have little impact on the natural environment, their power generation capacities are influenced by natural circumstances, which makes it difficult to correspond to the required power load stably. To cope with this, as the power generation system shown in FIG. 1, electric power generated by the power generation device 101 is stored temporarily in a power accumulation system 104, and the electric power stored in accordance with requirements from the power load connected to the end of the transmission system 102 is supplied to the power load via the transmission system 102.

The power accumulation system 104 has a plurality of storage units 105 that stores DC power for storing electric power. Electric power generated by the power generation device 101 is converted into DC power by an AC/DC converter 103, and the converted DC power is stored by the power accumulation system 104. Since electric power required from the power load is sent via the AC transmission system 102, the DC power stored in the power accumulation system 104 is converted into AC power by a DC/AC converter 106, and supplied to the load via the transmission system 102.

### Embodiment 1

[Description of Power Accumulation System]

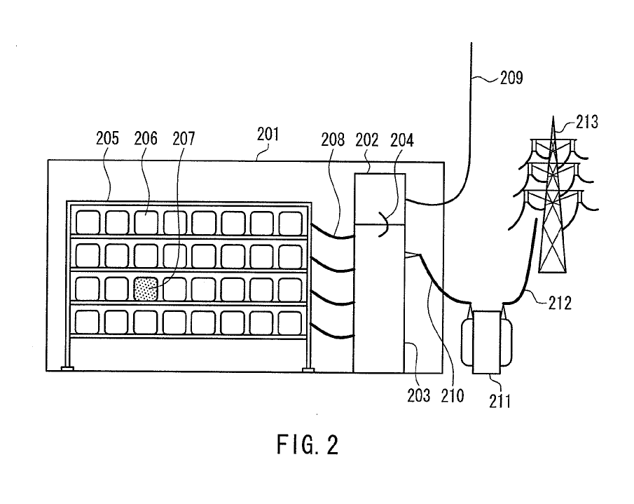

FIG. 2 is a view schematically showing a configuration of the entire power accumulation system according to the present invention, as a configuration example of Embodiment 1.

As shown in FIG. 2, as one example, the power accumulation system according to Embodiment 1 includes, inside a power accumulation system building 201, a control device 202, a power conversion device 203, storage units 206 as storage bodies capable of storing predetermined electric power, and a storage module 207 also as a storage body. Regarding facilities generally required in electrical facilities such as an extra-high circuit breaker, the illustration and the description will be omitted.

In the power accumulation system of the present embodiment, the storage unit 206 is composed of a plurality of lead storage batteries (storage elements) that are bound tightly using a wooden frame, for example. As one example, each of the storage units 206 has rating characteristics of 72 V, 150 Ah. In FIG. 2, a battery shelf 205 contains 4×8 storage units 206. However, depending on an amount of electric power to be stored in the power accumulation system, there is a power accumulation system that includes thousands of the storage units 206.

As shown in FIG. 2, in the power accumulation system of the present embodiment, one of the storage units 206 is replaced by the storage module 207. In the present specification, the storage unit refers to one that is an assembly of storage elements capable of storing electric power, and that causes electric characteristics of the storage elements to directly become input/output characteristics of the storage body when electric power is input/output via a voltage terminal. Further, although having a commonality with the storage unit in that electric power can be stored using the assembly of storage elements, the storage module refers to one that includes an input/output characteristic adjustment part having a function of controlling input/output characteristics of electric power of storage elements, and that can change input/output characteristics of electric power as a storage body.

The storage units 206 and/or the storage module 207 contained in each row of the battery shelf 205 are connected to each other in series using a connection line (not shown), and the serially-connected body composed of the storage units 206 and/or the storage module 207 is connected to the power conversion device 203 via a battery power line 208. In the state shown in FIG. 2, i.e., when a total of eight units/module are connected in each row, the rating per row of the shelf becomes 576 V, 150 Ah.

Four battery power line 208 groups are routed through a DC circuit breaker (not shown) arranged in the power conversion device 203 and connected to each other in parallel, and then are connected to a charge/discharge circuit for storage battery group (not shown) inside the power conversion device 203. A bidirectional DC/AC conversion circuit (not shown) provided in the power conversion device 203 is connected to a power system line 213 via a power leading line 210, a transformer 211 and a power system leading line 212. Further, the control device 202 controls the power conversion device 203 via a control signal line harness 204. The control device 202 can receive an instruction from the outside (e.g., a central control computer of a power system administrator) by means of a communication line 209 for example, and transmit the state of the power accumulation system using the communication line 209. When receiving an instruction from the outside, the control device 202 executes charge/discharge at the respective storage units in accordance with the state of the storage unit 206 group.

[Description of Storage Module]

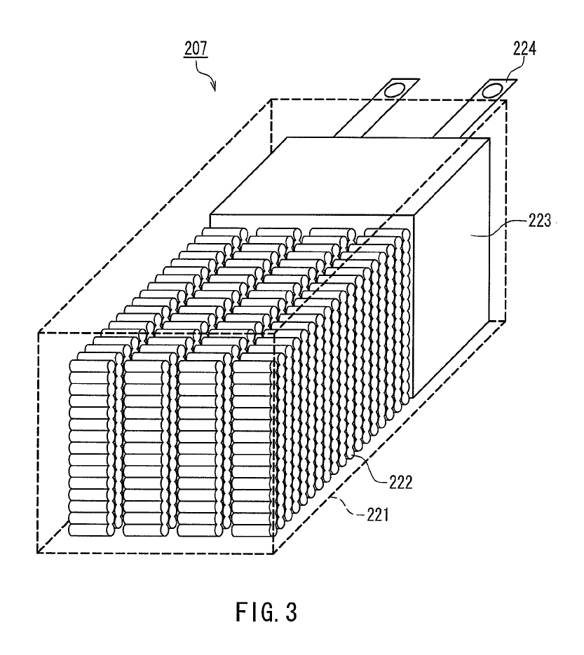

FIG. 3 is a view showing a configuration example of the storage module 207 as a storage body used in the power accumulation system according to the present embodiment.

As shown in FIG. 3, the storage module 207 used in the power accumulation system of the present embodiment contains, inside a housing 221 that forms an outline of the storage module 207, a battery group 222 as storage elements and an input/output characteristic adjustment part 223.

As one example, the battery group 222 is composed of 2048 lithium-ion battery cells, each having a diameter of 18 mm, a length of 65 mm and a nominal rating of 3.6 V, 1.5 Ah. Thirty-two groups of the battery cells, each group having a rating of 230.4 V, 1.5 Ah by connecting 64 battery cells in series, are connected to each other in parallel via a current fuse (not shown), and connected to the input/output characteristic adjustment part 223.

The input/output characteristic adjustment part 223 approximates input/output characteristics of the storage module 207 that is composed of storage elements different from storage elements of the storage unit 206 to input/output characteristics of the storage unit 206 that is another storage body. Thus, by the input/output characteristic adjustment part 223 approximating input/output characteristics of the storage module to input/output characteristics of the storage unit 206, electric power can be input and output collectively with respect to the serially-connected body in which the storage units 206 and the storage module 207 are used in combination. Here, the “approximation” in the invention of the present application means that, regarding input/output characteristics of electric power from the storage bodies, they are similar enough to be managed collectively as input/output characteristics of the same storage bodies. In other words, in the present embodiment, the approximation means that input/output characteristics possessed by the assembly of lead storage batteries as the storage unit 206 and input/output characteristics of electric power of the storage module whose storage elements are lithium-ion batteries have the same voltage characteristics and current characteristics, regardless of a difference in storage elements. Even when a plurality of storage units are produced using the same storage elements and the same specification, input/output characteristics of electric power of the respective storage units do not exactly coincide with each other due to errors or production errors per storage element. Similarly, the “approximation” described in the invention of the present application also permits a slight difference in input/output characteristics of electric power due to characteristic errors, production errors or the like of such storage elements, or a difference in an error range equivalent to such characteristic errors and production errors. Therefore, the “approximation” herein does not require exact conformity in input/output characteristics.

In the power accumulation system of the present embodiment, the input/output characteristic adjustment part 223 adjusts, regardless of the type of storage elements practically storing electricity, input/output characteristics of electric power of the storage module 207 such that the storage module 207 and the storage units 206 become storage bodies exhibiting the same electric behavior when seen from a power line terminal 224, which is a terminal for connection to the outside. Thereby, even when the storage unit 206 is replaced by the storage module 207, the power conversion device 203 can control the serially-connected body in which the storage unit 206 and the storage module 207 are used in combination, in the same manner as the serially-connected body composed only of the storage units 206. Because of this, even when the storage unit 206 needs to be replaced due to failures, aging or other reasons for example, by replacing the storage unit 206 with the storage module disclosed in the present embodiment, the power conversion device 203 of the power accumulation system can perform the same collective control before and after the replacement of the storage unit. The configuration of the input/output characteristic adjustment part 223 of the storage module 207 will be detailed later.

The power line terminal 224 from the input/output characteristic adjustment part 223 is formed so as to protrude from the housing 221 of the storage module 207. In the state where the storage module 207 is contained in the battery shelf 205 shown in FIG. 2, the power line terminal 224 is connected tightly to another storage unit 206, or another storage module 207, or the battery power line 208 by a power line.

Although, in the above description, lithium-ion batteries are used as the battery group 222, the batteries forming the battery group 222 are not limited to the lithium-ion batteries, and various types of storage elements can be used.

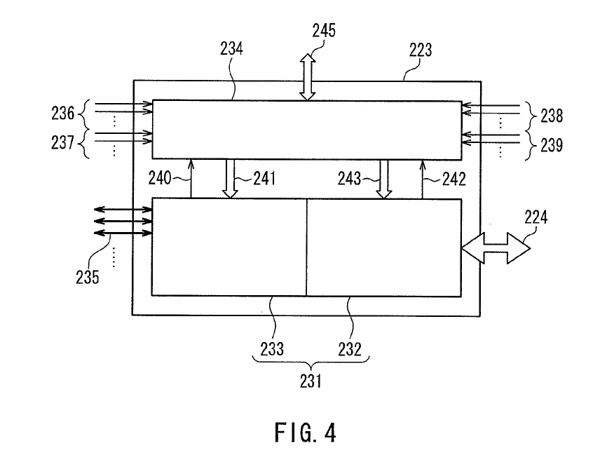

FIG. 4 is a block diagram showing a configuration of the input/output characteristic adjustment part 223 of the storage module 207 used in the power accumulation system of the present embodiment.

As shown in FIG. 4, the input/output characteristic adjustment part 223 includes an input/output function part 231 and a control part 234. The input/output function part 231 includes a power input/output part 232 that receives and outputs charge/discharge power in the battery power line 208 that has passed through the power line terminal 224, and a battery charge/discharge part 233 that appropriately charges and discharges the contained battery group 222 via a battery line 235. The control part 234 controls the power input/output part 232 and the battery charge/discharge part 233.

Incidentally, the input/output function part 231 can be configured by, for example, a bidirectional DC/DC conversion circuit that uses a general switching converter. Further, the power input/output part 232 and the battery charge/discharge part 233 can be formed of two separate switching converters, and also can be realized as a single switching converter. Note that the converter may either be an insulated converter or a non-insulated converter.

The input/output characteristic adjustment part 223 independently controls, by means of the control part 234, charge/discharge of the battery group 222 and input/output of electric power in the power line terminal 224. The control part 234 detects the state of the battery charge/discharge part 233 by a detection line 240, and controls the battery charge/discharge part 233 by a control line 241. Similarly, the control part 234 detects the state of the power input/output part 232 by a detection line 242, and controls the power input/output part 232 by a control line 243.

For example, as in the present embodiment, when lithium-ion batteries are used as the battery group 222 in the storage module 207, terminal voltages of respective battery cells are measured for grasping the charging state of electric power in the battery group 222. The control part 234 grasps the terminal voltages of the respective lithium-ion batteries using a first detection line 236. Further, for grasping the state of the battery group 222, a second detection line 237 that measures the temperature of at least one battery cell is arranged, for example.

The control part 234 generally can be configured by installing a program on an arithmetic circuit, such as a microprocessor and a digital signal processor. By configuring advanced programming, the storage module 207 can behave in the same manner as other storage units 206 after setting of the initial state. However, through the longtime operation of the power accumulation system, deviation may occur between the motion of the storage module 207 and the motion of another storage unit 206 or another incorporated storage module 207. Further, when the ambient temperature of other storage units 206 changes, etc., there is a possibility that the initial program cannot cause input/output characteristics of the storage module 207 to follow input/output characteristics of the storage units 206 adequately.

Because of this, in the input/output characteristic adjustment part 223 of the present embodiment, the states of other storage units 206 that constitute the same serially-connected body and are connected to the power conversion device 203 are detected, and the detected information is transmitted to the control part 234. More specifically, the follow-up accuracy can be improved further by providing a third detection line 238 that retrieves voltage information of the storage unit 206 and a fourth detection line 239 that retrieves temperature information of the storage unit 206, for correcting information inside the program of the control part 234 based on the information obtained from the third detection line 238 and fourth detection line 239.

Note that various information obtained by the detection lines and the control lines associated with the input/output characteristic adjustment part 223 may either be analog values or digital values. Further, the detection lines and the control lines may either be parallel lines or serial lines. Further, the control part 234 may be provided with an external communication line 245 for transmission and reception of signals with the outside of the storage module 207. Although the provision of the external communication line 245 is not essential, the external communication line 245 allows the control part 234 to communicate with another storage module 207, the control device 202 and the power conversion device 203 of the power accumulation system, and further the central control computer of the power system administrator arranged outside the power accumulation system, etc. For example, communication with other storage modules 207 permits mutual cooperative operation. Moreover, communication with the control device 202, the power conversion device 203, the central control computer of the power system administrator, etc., allows the control part 234 to receive control from these higher-level devices, whereby motions required to the power accumulation system can be performed more accurately.

Note that the input/output characteristic adjustment part 223 may include various types of switches for allowing the administrator to directly control the motion of the storage module 207. Further, the storage module 207 may include a display part that is formed of a display device such as a lamp, a meter, and an LED (liquid crystal) panel, and that displays various states of the storage module 207 itself (e.g., the voltage, temperature and remaining capacity) and states of other storage units 206 detected by the control part 234 (e.g., the voltage, temperature and others).

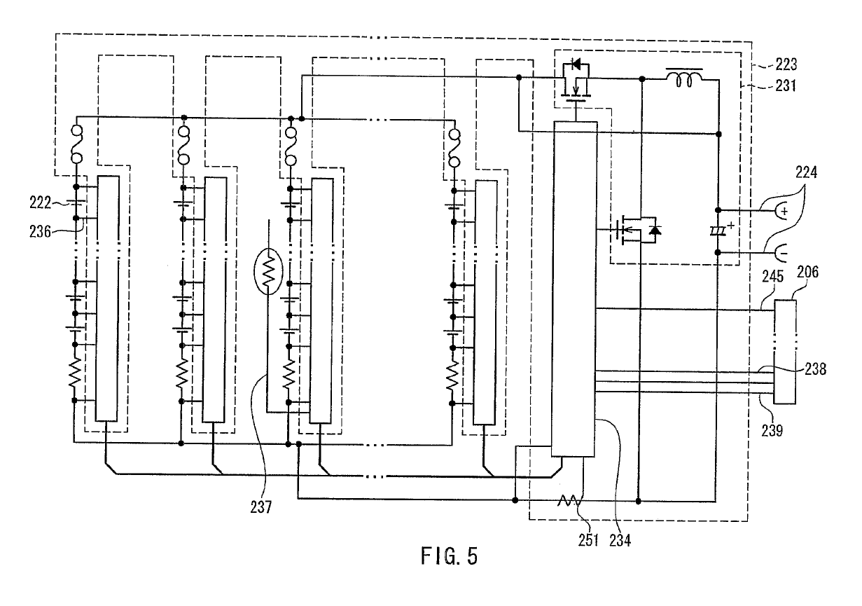

FIG. 5 is a circuit block diagram illustrating a configuration of the storage module 207 more specifically, based on the contents described using FIGS. 3 and 4.

Except for the serially-connected body parts of batteries that constitute the battery group 222 composed of a plurality of lithium-ion batteries, FIG. 5 shows respective constituent elements of the input/output characteristic adjustment part 223. The control part 234 is connected to the second detection line 237 that detects the temperature of the battery group 222, and the first detection line 236 that detects the output voltage of the battery group 222. The control part 234 is connected further to the third detection line 238 and the fourth detection line 239 that detect the temperature and the voltage of the storage unit 206, respectively, and further the external communication line 245. Although, in FIG. 5, the external communication line 245 is connected only to the storage unit 206, it can be connected to another storage unit 206, the control device 202 and the power conversion device 203 of the power accumulation system, and further to the outside of the power accumulation system via the storage unit 206 or by detouring around the storage unit 206. A reference numeral 251 indicates a current sensor that detects an output current from the storage module 207. By the current sensor 251, an amount of the output current of the storage module 207 can be monitored in the control part 234.

As described above, the control part 234 generally is composed of a microprocessor, a digital signal processor or the like, and controls the input/output characteristic adjustment part 223 through predetermined steps in accordance with the program (not shown). By approximating input/output characteristics of the storage module 207 to input/output characteristics of the storage unit 206 and keeping the power line terminal 224 at a constant voltage, this program performs the input/output of electric power that imitates the charge/discharge of the storage unit 206. The voltage is set to simulate the terminal voltages of other storage units 206 so as to be changed in the similar manner. Although various methods are considered as means for simulating the output voltage, it is possible to suitably use the following method: previously retrieving, as a program, input/output voltage characteristics and input/output current characteristics in accordance with the type of storage units 206 used; detecting the output current in the power input/output part 232 and the temperature inside/outside the storage module 207; and estimating a terminal voltage by calculating an effective capacity of the storage unit 206 at any given time based on the temperature detected.

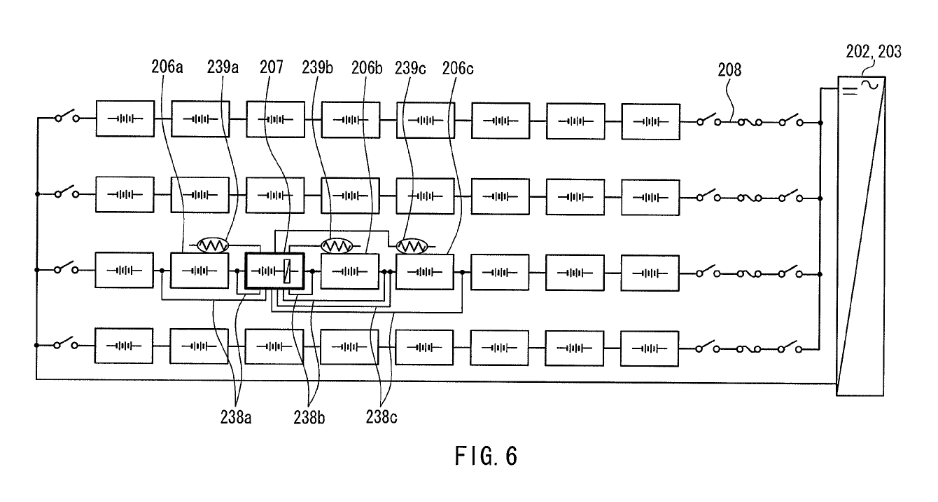

FIG. 6 is a circuit block diagram showing in detail the configuration of the entire power accumulation system of the present embodiment shown as FIG. 2.

In FIG. 6, not only the entire configuration but also a means by which the storage module 207 having replaced the storage unit 206 detects states of the surrounding storage units 206 are illustrated in more detail.

Specifically, as shown in FIG. 6, the replaced storage module 207 includes three sets of the third detection lines 238 (238a, 238b, 238c) that respectively detect output voltages of the neighboring three storage units 206 (206a, 206b, 206c), and the fourth detection lines 239 (239a, 239b, 239c) that respectively detect temperatures of the storage units 206 (206a, 206b, 206c) using temperature detection elements. By imitating the behavior of the surrounding storage units 206 grasped by these detection lines, i.e., by imitating the change in input/output voltage/current, the input/output characteristic adjustment part 223 adjusts the output voltage/current of the storage module 207.

The above-described detection of the actual motion states of the surrounding storage units 206 in real time as shown in FIG. 6 is not an essential configuration in the power accumulation system of the present invention. However, such a configuration allows the storage module 207 to simulate the storage units 206 with fewer errors.

[Description of Method for Controlling Storage Module]

Here, a method for controlling the storage module used in the power accumulation system described as the present embodiment will be described.

The method for controlling the storage module of the present invention is directed to a storage module that includes storage elements capable of storing electric power and an input/output characteristic adjustment part for controlling input/output characteristics of electric power of the storage elements, and that is used as a storage body whose electric power is input and output by a power conversion device in the power accumulation system. Further, the input/output characteristic adjustment part of the storage module approximates input/output characteristics of the storage module to input/output characteristics of another storage body used in the power accumulation system.

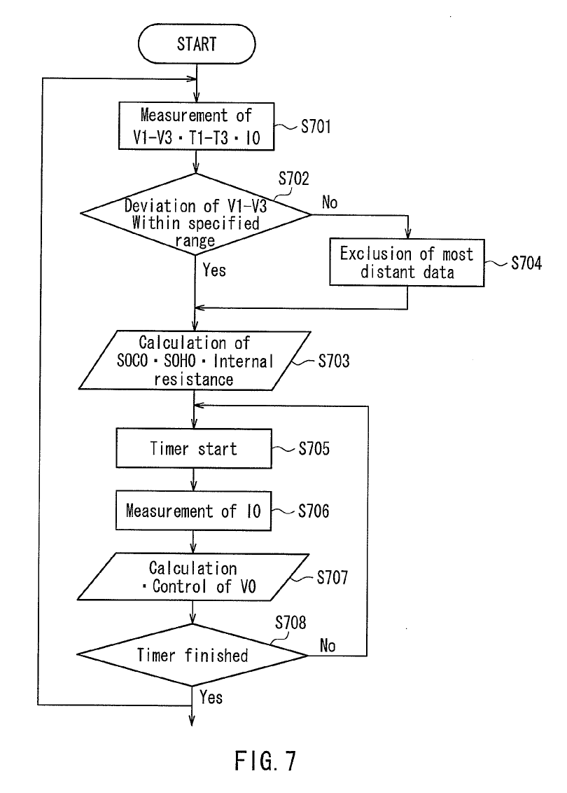

FIG. 7 is a flowchart showing one example of a program of the control part 234 that allows the control part 234 to detect voltages and temperatures of the three adjacent storage units 206a, 206b, 206c shown in FIG. 6 for correcting own behavior.

In FIG. 7, the voltage and temperature of the adjacent first storage unit 206a are V1 and T1, the voltage and temperature of the second storage unit 206b are V2 and T2, and the voltage and temperature of the third storage unit 206c are V3 and T3, respectively. Further, the output current and output voltage of the storage module 207 are I0 and V0, respectively.

As shown in FIG. 7, when the program is initialized and starts its operation, first, in a step S701, the control part 234 measures the output voltages V1, V2, V3 and the temperatures T1, T2, T3 of the storage units 206a, 206b, 206c. Further, the control part 234 measures the output current I0 flowing in the output 251 of the storage module 207 (see FIG. 5). For removing noises in the measurement, it is desirable to perform measurements plural times and eliminate abnormal values.

Next, in a step S702, the control part 234 judges the presence of abnormal storage unit 206 from the detected output voltage data V1, V2, V3 of the respective storage units 206. For example, when maximum/minimum values of the terminal voltages of the measured storage units 206 do not exceed the specified range, e.g., when no deviation is found that exceeds 5% from the specified range, the control part 234 regards the output voltage values as normal (Y) and proceeds to a next step S703.

Meanwhile, when abnormality is found (N) in the detected output voltage data V1, V2, V3 of the respective storage units 206, the control part 234 excludes data whose value is most distant from the rest of the data in a step S704 and proceeds to a next step S703. At this time, it is desirable to notify the outside about the detected abnormality of the storage unit 206, such as by transmitting predetermined signals, displaying the abnormality on the display part, or the like.

In the step S703, based on the information of the neighboring storage units 206 obtained in the step S701 and data accumulated in the operation of the power accumulation system, the control part 234 calculates apparent battery characteristics, such as an apparent remaining capacity SOC0, an apparent remaining life SOH0 and an apparent internal resistance value, to be imitated and behaved by the storage module 207.

From a step S705 through a step S708, based on the numerical value groups calculated in the step S703, the control part 234 calculates, from an instantaneous value I0 of current flowing in the storage module 207, a terminal voltage V0 to be output, and passes it to the input/output function part 231 as a control value.

During a predetermined time in which a timer set in the step S705 counts down, the control part 234 repeats the steps S706 and S707. When the control part 234 judges that the timer is finished (Y) in the step S708, it returns to the step S701 and detects various states of the external storage units 206 again.

Thus, by the control part 234 controlling the input/output function part 231 in accordance with the program shown in FIG. 7, the input/output characteristic adjustment part 223 controls the storage module 207. Consequently, only internal processing of the storage module 207 is necessary to correspond to a change in an internal current I0 of the storage module 207 that is required to have a high follow-up speed. Thereby, it is unnecessary to perform high-speed measurements at the outside of the housing 221 of the storage module 207 that are concerned to be noisy.

In this manner, the control part 234 can calculate the internal remaining capacity SOC, the internal remaining life SOH, an allowable current, etc., of the battery group 222 arranged inside the storage module 207 easily and appropriately using generally known means, thereby managing the battery group 222 via the battery charge/discharge part 233. In this case, the apparent SOC0 and SOH0 obtained in the step S703 in the flowchart of FIG. 7 serve as guidelines for the control part 234 to derive an operation plan for the battery group 222 present in the storage module 207.

In the above description, in the power accumulation system according to the present embodiment, the storage module used as a replacement for the storage unit moves so as to imitate input/output characteristics of the replaced storage unit. Further, the above describes the method for controlling the storage module used in the power accumulation system according to the present embodiment.

In the power accumulation system of the present embodiment, when a storage unit needs to be replaced, the input/output characteristic adjustment part of the storage module can imitate the motion of the storage unit even when electric characteristics of the replacing storage module are different from electric characteristics of the storage unit to be replaced. Thus, it is possible to collectively control the serially-connected body formed of the storage unit and the storage module, without changing the contents of control at a control means that controls the entire power accumulation system. Thereby, in the power accumulation system according to the present embodiment, even after the replacement of the storage unit in the power accumulation system provided with a plurality of storage units, it is possible to control the entire power accumulation system easily. Specifically, even when the same conventional storage unit cannot be used as a replacement due to regulation, an improvement of the product, etc., and further, even when input/output voltage characteristics of the storage unit have changed after a lapse of the operation time of the power accumulation system, the storage module can be used as a battery element from a wide range of choice. This is extremely useful in view of the practical use of the power accumulation system.

Here, the motion control in the input/output characteristic adjustment part of the storage module according to the present embodiment will be described further by showing some specific cases.

First, in the case where the storage module 207 receives a charging current exceeding a preset remaining capacity, the control part 234 regards this that equalizing charge is performed, and does not charge the battery group 222 further by bypassing the charging current. As a means for bypassing the charging current, in the converter constituting the power input/output part 232, a method can be adopted in which opening/closing duties of the semiconductor switch is adjusted to cause heat loss, for example.

Further, by setting the control part 234 of the storage module 207 so that the storage capacity of the storage module 207 in a predetermined charge/discharge depth exceeds the storage capacity of the storage unit 206, and attaching the storage module into the power accumulation system so that an initial charge amount of the storage module 207 is matched with that of the storage unit 206, it is possible to effectively prevent the remaining capacity from being too low from a predetermined value in the normal operation. Further, even when the remaining capacity becomes too low, the control part 234 can order the power input/output part 232 to reduce a voltage or stop discharge if discharge current flows.

Incidentally, lead storage batteries and nickel metal hydride storage batteries generally have lower charge/discharge efficiency as compared with lithium-ion storage batteries and high self-discharge characteristics. Therefore, it is desirable that the control part 234 performs control to adjust the characteristic differences due to the type of storage batteries. For example, by instructing the power input/output part 232 to perform motion to cause heat loss, the motion of the storage module 207 can be one that imitates the charge/discharge efficiency at the storage unit 206. Further, power loss caused in the case of performing such a control can be utilized as a power source for a fan provided to cool the battery group 222 or peripheral circuits, for example.

### Embodiment 2

Next, as Embodiment 2 of the power accumulation system according to the present invention, the case will be described in which the storage bodies in the power accumulation system are plural types of storage modules provided with different types of storage elements. Further, a control method for correcting changing mode of the terminal voltage and the remaining capacity of the battery group (storage elements) between the storage modules provided with different types of storage elements.

[Description of Power Accumulation System]

A power accumulation system described in Embodiment 2 is different from the power accumulation system provided with the storage unit and the storage module as storage bodies described as Embodiment 1, in that it includes two different types of storage modules as storage bodies capable of storing predetermined electric power.

Therefore, the power accumulation system described in Embodiment 2 has the same configuration as the power accumulation system described as Embodiment 1, although the configurations of the storage bodies are different from each other. Therefore, the entire configuration of the power accumulation system described in FIG. 2, i.e., the configuration examples of the power accumulation system building 201, the control device 202, the power conversion device 203, the battery shelf 205, the battery power line 208, etc., directly serve as configuration examples of the power accumulation system of the present embodiment. Further, the configurations and connections of the power leading line 210, the transformer 211, the power system leading line 212, the power system line 213, etc., shown in FIG. 2 directly serve as configuration examples of the power accumulation system of Embodiment 2.

[Description of Storage Module]

As described above, the power accumulation system of the present embodiment is different from the power accumulation system of Embodiment 1, in that two types of storage modules, which are different in storage elements, are used as storage bodies. Hereinafter, the storage modules used in the power accumulation system of the present embodiment will be described with reference to the drawings.

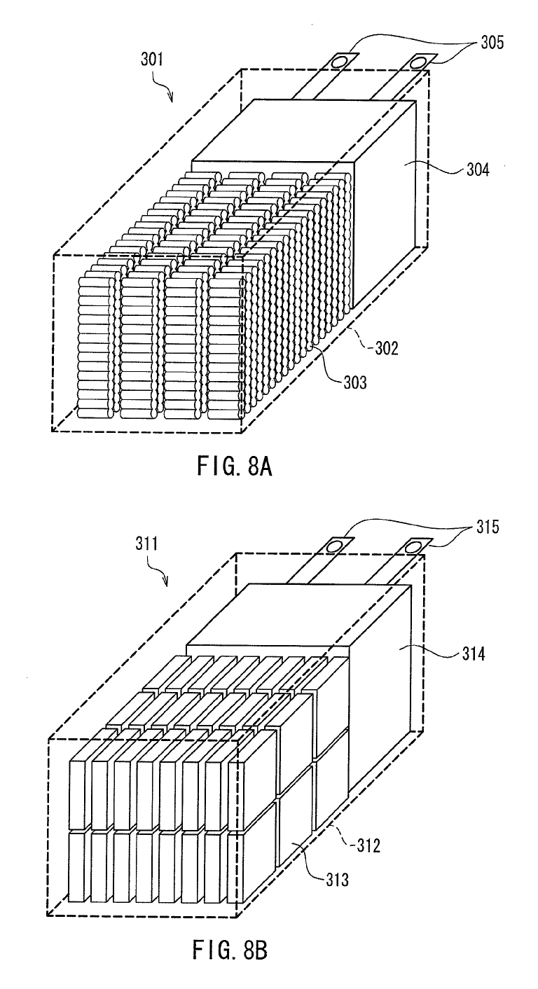

In the present embodiment, FIG. 8 shows a configuration example of a first storage module 301 contained in the battery shelf 205 (see FIG. 2) of the power accumulation system, and a configuration example of a second storage module 311 also contained in the battery shelf 205. Here, the description is given to the case where the first storage modules 301 are arranged in place of the storage units 206 in FIG. 2, and the second storage module 311 is arranged in place of the storage module 207 in FIG. 2.

FIG. 8A shows the configuration of the first storage module 301, and FIG. 8B shows the configuration of the second storage module 311.

The storage module 301 houses a plurality of storage batteries as storage elements, and has rating characteristics of 100 V, 100 Ah. In practice, thousands of the first storage modules 301 are contained in the battery shelf 205.

As shown in FIG. 8A, the first storage module 301 includes a housing 302 that forms a shell of the first storage module 301, a battery group 303 as storage elements, and an input/output characteristic adjustment part 304. As one example, the battery group 303 of the first storage module 301 is composed of 2048 lithium-ion battery cells, each having a diameter of 18 min, a length of 65 mm and a nominal rating of 3.6 V, 1.4 Ah. In the battery group 303 composed of these lithium-ion battery cells, thirty-two groups of the battery cells, each group having a rating of 230.4 V 1.4 Ah by connecting 64 battery cells in series, are connected to each other in parallel via a current fuse not shown in FIG. 8A, and connected to the input/output characteristic adjustment part 304.

A power line terminal 305 from the input/output characteristic adjustment part 304 is formed so as to protrude from the housing 302. In the state where the first storage module 301 is contained in the battery shelf 205 shown in FIG. 2, the power line terminal 305 is connected tightly to the neighboring another first storage module 301, the second storage module 311 (described later), or the battery power line 208 by a power line.

The second storage module 311 is arranged as a replacement for the first storage module 301, and has a rating of 100 V, 150 Ah.

As shown in FIG. 8B, in the second storage module 311, as one example, rectangular-shaped lithium-ion batteries, each having a nominal rating of 3.8 V, 84 Ah, form a battery group 313. The battery group 313 composed of 48 lithium-ion battery cells has a rating of 182.4 V, 84 Ah by connecting all the battery cells in series, and is connected to an input/output characteristic adjustment part 314 via a current fuse not shown in FIG. 8B.

Further, in a housing 312 that forms a shell of the second storage module 311, a power line terminal 315 from the input/output characteristic adjustment part 314 is formed so as to protrude from the housing 312. In the state where the second storage module 311 is contained in the battery shelf 205 shown in FIG. 2, the power line terminal 315 is connected tightly to another first storage module 301, another second storage module 311, or the battery power line 208 by a power line.

Although, in the present embodiment, lithium-ion batteries are used in the first storage module 301 and the second storage module 311 as the battery group as the storage elements, different types of the storage elements other than lithium-ion batteries can be used as the batteries of the battery group that is incorporated into the first storage module and the second storage module in the power accumulation system of the present embodiment.

In the present embodiment, the storage unit 206 used in the Embodiment 1 is not used, and two types of storage modules are used. Both of the storage modules include the input/output characteristic adjustment part containing the control part, and can adjust input/output characteristics of electric power from the storage elements. Therefore, by performing control in the input/output characteristic adjustment part of the first storage module and the input/output characteristic adjustment part of the second storage module so that two types of storage modules have the same input/output characteristics, it becomes possible to collectively control the input/output voltage as the entire power accumulation system while using two types of storage modules in the form of the serially-connected body.

Note that, in the first storage module 301 and the second storage module 311, the configuration of the input/output characteristic adjustment part may have the same configuration as the input/output characteristic adjustment part 223 of the storage module 207 described in Embodiment 1 using FIG. 4. The first storage module 301 and the second storage module 311 used in the power accumulation system of Embodiment 2 are different from the storage module 207 used in Embodiment 1 shown in FIG. 4, only in the input/output characteristic adjustment part, specifically, the contents of control at the control part that controls the input/output function part.

[Method for Controlling Storage Modules]

Hereinafter, control of input/output characteristics of two types of storage modules in the present embodiment will be described.

As described in Embodiment 1, the input/output characteristic adjustment part of the storage module is provided with the control part that generally is composed of a microprocessor, a digital signal processor, etc., and that controls the input/output characteristic adjustment part through predetermined steps in accordance with a predetermined program. The program of the control part performs input/output of electric power by keeping the power line terminals 305, 315 at a constant voltage, and the voltage is set so as to change in accordance with the states of the storage batteries contained in the storage module. As a requirement for changing the terminal voltage, various requirements can be considered. For example, it is possible to suitably use a predicted value of the substantial remaining capacity in the actual operation.

In other words, the control parts respectively controlling the input/output characteristic adjustment parts 304, 314 obtain and calculate the remaining capacities, remaining lives and allowable currents of the battery groups 303, 313 arranged inside the storage modules 301, 311 by using various techniques including known methods, and manage the battery groups 303, 313 via the battery charge/discharge parts inside the input/output characteristic adjustment parts 304, 314. At this time, for example, an estimated remaining capacity calculated based on the degree of degradation, temperature, output current, internal resistance, etc., of batteries is set as a terminal voltage that is related to a numerical value normalized by a nominal rating capacity.

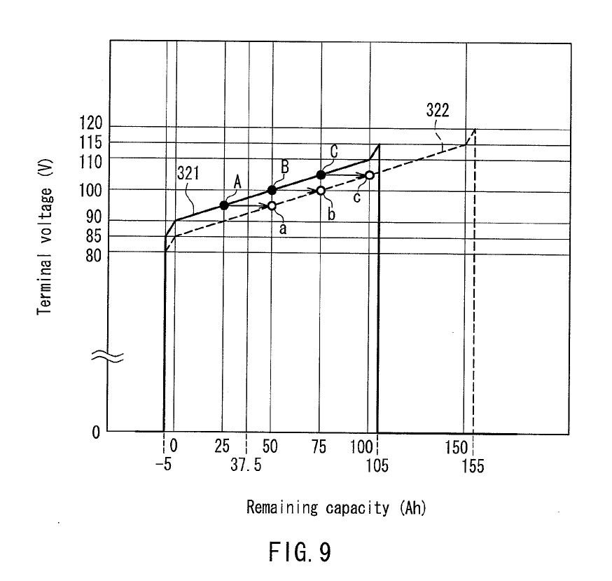

FIG. 9 shows a relationship between a terminal voltage (V) that is a value of the output voltage in the storage module in the present embodiment and a remaining capacity converted value under nominal capacity that is a numerical value (Ah) estimated as a remaining capacity.

In FIG. 9, a solid line 321 indicates one example of terminal voltage control of the power line terminal 305 in the first storage module 301.

As shown in FIG. 9, when 50% of an actual remaining capacity SOC (%) of the battery group 303 of the first storage module is assumed to be the remaining capacity converted value under nominal capacity of 50 Ah considering that the first storage module 301 has the nominal capacity of 100 Ah, the terminal voltage at this time is defined at 100 V. In a section of the remaining capacity converted value under nominal capacity from 0 Ah to 100 Ah, the voltage is varied with a gradient of 1 V per 5 Ah of the remaining capacity converted value under nominal capacity. Further, in the section of the remaining capacity converted value under nominal capacity from 0 Ah to −5 Ah and from 100 Ah to 105 Ah, the voltage is varied with a gradient of 1 V per 1 Ah.

For the sake of safety, the input/output is shut off in the section of the remaining capacity converted value under nominal capacity below −5 Ah and over 105 Ah.

Meanwhile, in FIG. 9, a broken line 322 indicates one example of terminal voltage control of the power line terminal 315 in the second storage module 311.

As shown in FIG. 9, similarly to the first storage module 301, when 50% of the actual remaining capacity SOC of the battery group 313 is assumed to be the remaining capacity converted value under nominal capacity of 75 Ah considering that the second storage module 311 has the nominal capacity of 150 Ah, the terminal voltage at this time is defined at 100 V. In the section of the remaining capacity converted value under nominal capacity from 0 Ah to 150 Ah, the voltage is varied with a gradient of 1 V per 5 Ah of the remaining capacity converted value under nominal capacity. Further, in the section of the remaining capacity converted value under nominal capacity from 0 Ah to −5 Ah and from 150 Ah to 155 Ah, the voltage is varied with a gradient of 1 V per 1 Ah.

In the second storage module 311, for the sake of safety, the input/output is shut off in the section of the remaining capacity converted value under nominal capacity below −5 Ah and over 155 Ah.

It is considered that, in many cases, in the actual charge/discharge operation, the storage module generally is not used at a discharge depth DOD (%) of 100%, but at about 50%, for example, with hope for a longer life and higher reliability. In the first storage module 301, when a section of the discharge depth DOD of 50% is set in the range of 25% above and below the actual remaining capacity SOC of 50%, it ranges from a filled circle A to a filled circle Con the plot line 321. That is, in the normal use conditions, the storage module is operated in the section of the remaining capacity converted value under nominal capacity from 25 Ah to 75 Ah, which is a region having a width of 50 Ah.

Here, in the power accumulation system of the present embodiment, when at least part of the first storage modules 301 is replaced by the second storage module 311, the second storage module 311 is operated in the range of 25% above and below the remaining capacity converted value under nominal capacity of 75 Ah, which corresponds to the actual remaining capacity SOC of 50%. In other words, the storage module is operated in the section of the remaining capacity converted value under nominal capacity from 50 Ah to 100 Ah, which is a region having a width of 50 Ah. The section ranges from an open circle a to an open circle c on the plot line 322.

In FIG. 9, as indicated by arrows pointing from the plot line 321 to the plot line 322, the voltage of the first storage module 301 at the remaining capacity converted value under nominal capacity of 25 Ah shown by the filled circle A is equivalent to the voltage of the second storage module 311 at the remaining capacity converted value under nominal capacity of 50 Ah shown by the open circle a. Similarly, the voltage of the first storage module 301 at the remaining capacity converted value under nominal capacity of 50 Ah (filled circle B) is equivalent to the voltage of the second storage module 311 at the remaining capacity converted value under nominal capacity of 75 Ah (open circle b). Further, the voltage of the first storage module 301 at the remaining capacity converted value under nominal capacity of 75 Ah (filled circle C) is equivalent to the voltage of the second storage module 311 at the remaining capacity converted value under nominal capacity of 100 Ah (open circle c).

As described above, in the power accumulation system of the present embodiment, control is performed between the first storage module 301 and the second storage module 311 so that they can be approximated to each other based on the relationship between the terminal voltage and the remaining capacity. Thus, by performing control with respect to both of the first storage module 301 and the second storage module 311 so that the storage amounts of the respective storage module groups are matched with each other with reference to the actual remaining capacity SOC, the storage modules provided with different types of battery groups can be combined easily regardless of the type of the battery groups constituting the storage modules and can be used in the power accumulation system. Especially, since the different types of storage modules can be regarded as the same storage modules, and the serially-connected body formed therefrom can be controlled collectively without the necessity of changing the contents of control at the control means that controls the entire power accumulation system, the entire power accumulation system can be controlled easily using the storage modules having different charge characteristics as storage units, in the power accumulation system provided with a plurality of storage units.

Therefore, even when there is no choice but to replace part of the storage modules with storage modules with different specifications due to regulation, an improvement of the product, etc., and also even when not all of the storage modules have the same specification from the beginning, the above configuration exhibits high practicality. Further, not only to the case of changing the storage modules or using, in combination, the storage modules with different specifications, but also to the case where the same type of storage modules have been used but their input/output characteristics have changed after a lapse of the operation time of the power accumulation system for example, the above configuration has practicality that allows the entire power accumulation system to be controlled collectively.

Although, in the present embodiment, two types of the storage modules are used in combination, the power accumulation system of the present embodiment is not limited to this example, and also can be applied suitably when three or more types of the storage modules are used together.

As described above, the power accumulation system according to the present invention provides a special effect of collectively controlling a plurality of the storage bodies entirely with ease. Especially when at least part of the storage bodies of the power accumulation system needs to be replaced, and different types of the storage bodies need to be used together, this effect can be exhibited. In other words, in the power accumulation system of the present invention, when part of the initial storage bodies needs to be replaced, input/output characteristics of electric power of replacing storage modules can be approximated to input/output characteristics of the storage units and other storage modules. Therefore, regardless of characteristics of the storage elements of the storage module, the storage bodies can be replaced without changing the control by the power conversion device provided in the power accumulation system.

Further, the power accumulation system of the present invention can have a current bypass function and a heat loss function. Therefore, the power accumulation system can be one that is favorable in view of protection of storage elements at the time of the equalizing charge and improvement of charge/discharge efficiency.

Further, according to the method for controlling the storage module of the present invention, between the storage units and different storage modules having different storage elements, it is possible to favorably approximate input/output characteristics of electric power.

Incidentally, in the above Embodiment 1, as the storage unit used in the power accumulation system, the storage unit in which a plurality of lead storage batteries are bound tightly using a wooden frame is described. However, the storage elements to be used in the storage unit used in the power accumulation system according to the present invention are not limited to lead storage batteries, and various types of the storage elements can be used, such as nickel-cadmium storage batteries, nickel metal hydride storage batteries, lithium-ion storage batteries, electric double layer capacitors, lithium-ion electric double layer capacitors and flywheel storage devices.

Further, as the power accumulation system, the power accumulation system whose entire body is arranged inside the system building and in which the storage bodies are arranged in the battery shelf with plural rows is illustrated and described using FIG. 2. However, the power accumulation system according to the present invention is not limited to such a comparatively large-scale system, and for example, can be applied to a home power accumulation system in which a plurality of storage bodies are received in a battery box and that includes the control device and the power conversion device for controlling input/output of electric power from these storage bodies, and a comparatively small-scale power accumulation system to be attached to a specific electric device.

Further, in the storage module, as the storage elements constituting the battery group, other than the lithium-ion batteries shown as one example, various types of secondary batteries can be used, such as nickel metal hydride storage batteries, electric double layer capacitors, lithium-ion electric double layer capacitors and flywheel storage devices.

Further, in the power accumulation system of the invention of the present application, the use of the storage module provides the possibility of effectively solving various problems related to storage bodies used in the power accumulation system. Examples of the problems related to storage bodies include a difference in input/output characteristics due to different manufacturers, design factors such as adopted materials and the intended use, a difference in characteristics due to different production period, a difference in input/output characteristics caused by various changes in characteristics in actual working conditions, specifically, changes attributed to the storage amount of the terminal voltage, current, temperature, use, and deterioration in storage.

Further, regarding a change in voltage with a time constant from several milliseconds to several days due to polarization in chemical batteries, this problem also can be solved by adjusting input/output characteristics of the storage modules based on these characteristics using the input/output characteristic adjustment part.

Incidentally, for example, as to the power accumulation system configured primary for the operation using lead storage batteries, nickel-cadmium storage batteries, nickel metal hydride storage batteries, etc., the power conversion device often is configured to perform equalizing charge control, which is a type of overcharge. In order to cause the storage module provided with storage elements that do not correspond to the equalizing charge (e.g., lithium-ion storage batteries) to correspond to such a power accumulation system, it is possible to provide a function that allows a power conversion function of the storage module to bypass equalizing charge currents so that the storage module behaves as if it receives equalizing charge.

### INDUSTRIAL APPLICABILITY

The present application can be used effectively, together with various power generation facilities and power facilities, as a power accumulation system capable of charging and discharging electric power and a method for controlling a storage module as a storage body used in the power charge system.

1. A power accumulation system, comprising:
a plurality of storage bodies each being capable of storing predetermined electric power;
a power conversion device inputting and outputting electric power with respect to the storage bodies; and
a control device controlling motion of the power conversion device,
wherein at least part of the storage bodies is a storage module that includes storage elements capable of storing electric power and an input/output characteristic adjustment part for controlling input/output characteristics of electric power of the storage elements.

2. The power accumulation system according to claim 1,
wherein the storage module is arranged as a replacement for a storage unit that is formed by combining storage elements, and
the input/output characteristic adjustment part of the storage module approximates input/output characteristics of the storage module to input/output characteristics of the replaced storage unit in actual working conditions.

3. The power accumulation system according to claim 1, comprising, as the storage bodies, a first storage module capable of storing electric power by means of first storage elements and a second storage module capable of storing electric power by means of second storage elements having characteristics different from characteristics of the first storage elements,
wherein the input/output characteristic adjustment part of the second storage module approximates input/output characteristics of the second storage module to input/output characteristics of the first storage module.

4. The power accumulation system according to claim 3, wherein the second storage module is arranged as a replacement for the first storage module.

5. The power accumulation system according to claim 1, wherein the input/output characteristic adjustment part changes input/output characteristics of the storage module by manipulation from the outside of the storage module.

6. A method for controlling a storage module that includes storage elements capable of storing electric power and an input/output characteristic adjustment part for controlling input/output characteristics of electric power of the storage elements, and that is used as a storage body whose electric power is input and output by a power conversion device in a power accumulation system,
wherein the input/output characteristic adjustment part approximates input/output characteristics of the storage module to input/output characteristics of another storage body used in the power accumulation system.

7. The method for controlling a storage module according to claim 6, wherein, when the storage module is arranged in the power accumulation system as a replacement for another storage body, input/output characteristics of the storage module is approximated to input/output characteristics of the replaced another storage body.

8. The method for controlling a storage module according to claim 7, wherein the another storage body replaced by the storage module is a storage unit that is formed by combining storage elements.

9. The method for controlling a storage module according to claim 7, wherein the another storage body replaced by the storage module is a storage module different from the storage module, which includes another storage elements having input/output characteristics different from input/output characteristics of the storage elements used in the storage module and an input/output characteristic adjustment part for controlling the input/output characteristics.

10. The method for controlling a storage module according to claim 9, wherein a terminal voltage of the storage module is approximated to a terminal voltage of the replaced storage module different from the storage module, based on a relationship between the terminal voltage and a remaining capacity in the replaced storage module different from the storage module.

11. The method for controlling a storage module according to claim 10, wherein the terminal voltage of the storage module is approximated to the terminal voltage of the replaced storage module different from the storage module, so as to have a predetermined width above and below a value of the terminal voltage of the replaced storage module different from the storage module, at a predetermined capacity.
